(19) United States
(12) Patent Application Publication
(10) Pub. No.: US 2019/0243914 A1
(43) Pub. Date: Aug. 8, 2019

(54) PARALLEL QUERY PROCESSING IN A DISTRIBUTED ANALYTICS ARCHITECTURE

(71) Applicant: Adam Lugowski, Los Altos Hills, CA (US)

(72) Inventor: Adam Lugowski, Los Altos Hills, CA (US)

(21) Appl. No.: 15/891,678

(22) Filed: Feb. 8, 2018

(51) Int. Cl. G06F 17/30

(52) U.S. Cl. CPC G06F 17/30445; G06F 17/30463

(57) ABSTRACT

A query processing system may include a query input interface, a query execution subsystem, a plurality of data analytics nodes, and a query response subsystem. The query execution subsystem may analyze a query data object identified via the query interface to produce a query object vector. Each of the data analytics nodes may compare each value in the query object vector with a respective value in each of a plurality of corpus data vectors to produce a proximity value indicating a distance between the query data object vector and the corpus object vector in a multidimensional vector space. The query response subsystem may provide a user interface in which each of a subset of the proximity values are presented in a spatial-temporal proximity representation.

### TECHNICAL FIELD

The present invention relates generally to query systems architecture, and more specifically to the efficient execution of queries to identify and represent object proximity in a multi-dimensional vector space.

### DESCRIPTION OF RELATED ART

Concepts of proximity are integral to processing and ordering vast amounts of information in a variety of contexts. For instance, the notion of proximity is a common theme when analyzing data characterizing subjects as diverse as corporate financial reporting documents, books, websites, and people. In each context, objects are frequently searched, ordered, and organized based on their proximity to one another in some abstract sense. However, large-scale parallel processing of queries in complex proximity models requires substantial computing resources. Further, the results returned from such queries are often quite large, such that effectively analyzing and conveying query results imposes substantial additional data processing and management challenges. Given the centrality of proximity-related queries to modern data science, improved techniques are desired for quickly efficiently computing, unifying, and conveying the results of such queries.

### BRIEF SUMMARY

The following presents a simplified summary of the disclosure in order to provide a basic understanding of certain embodiments of the invention. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Various embodiments of the present invention relate generally to devices, systems, methods, and non-transitory machine-readable media for query processing. According to various embodiments, a system may include a query input interface operable to receive from a client machine a query request message identifying a query data object. The system may also include a query execution subsystem implemented on a hardware processor and operable to produce a query object vector based on the query data object. The query object vector may include a designated plurality of data values that each correspond with a respective dimension in a vector space.

According to various embodiments, the system may include a plurality of data analytics nodes that each include a respective one or more processors and a respective memory module. Each of the data analytics nodes may be operable to receive a respective query subset request message that includes the query object vector. Each of the data analytics nodes may also be operable to retrieve a respective corpus object vector for each of a respective subset of corpus data objects. Each of the respective corpus object vectors may include a respective plurality of data values that each corresponds with a respective dimension in a vector space. Each of the data analytics nodes may also be operable to compare each value in the query object vector with a respective value in the corpus object vector to produce a proximity value for each of the corpus object vectors. The proximity value indicating a distance between the query object vector and the corpus object vector in the vector space.

According to various embodiments, the system may include a query response subsystem operable to receive one or more of the proximity values determined by the data analytics nodes. The query response subsystem may also be operable to determine a respective temporal coordinate for each of a subset of the proximity values. Each respective temporal coordinate may identify a respective point in time associated with the respective corpus data object associated with the respective proximity value. The query response subsystem may also be operable to transmit a response message to the client machine providing access to a user interface that includes a graphical representation of a coordinate system. Each of the subset of the proximity values may be associated with a respective indicator positioned within the representation of the coordinate system. A first axis of the graphical representation of the coordinate system may correspond with the respective temporal coordinate. A second axis of the graphical representation of the coordinate system may correspond with the respective proximity value.

In some implementations, the subset of proximity values may include all proximity values that exceed a designated threshold. The query data object may be associated with a focal temporal coordinate identifying a focal point in time associated with the query data object, and the query data object may be associated with a focal indicator positioned within the coordinate system. The coordinate system may include an origin point at an intersection of the first axis and the second axis, and the focal indicator may be positioned at the origin point.

In particular embodiments, the query response system may be further operable to identify an originality value associated with the query data object. The originality value may include a statistical average of a first portion of the proximity values. The first portion of the proximity values may include each of the subset of the proximity values having a temporal coordinate less than the focal temporal coordinate. The originality value may be transmitted to the client machine via the user interface.

In particular embodiments, the query response system may be further operable to identify a legacy value associated with the query data object. The legacy value may include a statistical average of a first portion of the proximity values, which may include each of the subset of the proximity values having a temporal coordinate greater than the focal temporal coordinate. The legacy value may then be transmitted to the client machine via the user interface.

In particular embodiments, the query response system may be further operable to identify a latency value associated with the query data object. The latency value may include a statistical average of the temporal coordinates for a first portion of the proximity values. The first portion of the proximity values may include each of the subset of the proximity values having a temporal coordinate less than the focal temporal coordinate. The latency value may then be transmitted to the client machine via the user interface.

In particular embodiments, the query response system may be further operable to identify a continuity value associated with the query data object. The continuity value may include a statistical average of the temporal coordinates for a first portion of the proximity values. The first portion of the proximity values may include of each of the subset of the proximity values having a temporal coordinate greater than the focal temporal coordinate. The continuity value may then be transmitted to the client machine via the user interface.

In particular embodiments, the query data object and each of the corpus data objects may include a multi-page text document. Each of the dimensions in the vector space may correspond to a respective one or more words that occurs in one or more of the corpus data objects. Each of the dimensions in the vector space may correspond to a respective semantic property associated with one or more of the corpus data objects.

These and other embodiments are described further below with reference to the figures.

### BRIEF DESCRIPTION OF THE DRAWINGS

The disclosure may best be understood by reference to the following description taken in conjunction with the accompanying drawings, which illustrate particular embodiments.

FIG. 1 illustrates an example of a distributed query system that may be used in conjunction with techniques described herein and is configured in accordance with one or more embodiments.

FIG. 2 illustrates an example of a distributed query system node pool that may be used in conjunction with techniques described herein and is configured in accordance with one or more embodiments.

FIG. 3 illustrates one example of a server that may be used in conjunction with techniques described herein and is configured in accordance with one or more embodiments.

FIG. 4 illustrates an example of an object retrieval method, performed in accordance with one or more embodiments.

FIG. 5 illustrates an example of an object vectorization method, performed in accordance with one or more embodiments.

FIG. 6 illustrates an example of a query evaluation method, performed in accordance with one or more embodiments.

FIG. 7 illustrates an example of a temporal-proximity spatial representation method, performed in accordance with one or more embodiments.

FIG. 8 illustrates an example of a user interface including a temporal-proximity spatial representation, provided in accordance with one or more embodiments.

FIGS. 9A-9F illustrates additional examples of a user interface including a temporal-proximity spatial representation, provided in accordance with one or more embodiments.

FIG. 10 illustrates an example of a query processing method, performed in accordance with one or more embodiments.

FIG. 11 illustrates an example of a job distribution method, performed in accordance with one or more embodiments.

FIG. 12 illustrates an example of a node management method, performed in accordance with one or more embodiments.

FIG. 13 illustrates an example of a visual representation 1300, provided in accordance with one or more embodiments.

FIG. 14 illustrates an example of a visual representation method 1400, performed in accordance with one or more embodiments.

### DETAILED DESCRIPTION OF INVENTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of specific configurations of analytics nodes and particular types of query objects. However, it should be noted that the techniques of the present invention apply to a wide variety of distributed architectures and query objects. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

### EXAMPLE EMBODIMENTS

Techniques and mechanisms described facilitate the efficient execution and communication of queries used to identify proximate data objects. According to various embodiments, a distributed query system includes a scalable number of data analytics nodes. A query data object may be represented as a vector and then efficiently compared with a very large number of corpus data objects. The results from the query execution may then be provided in a comprehensible graphical interface. The system may be configured to handle a large number of queries in a rapid and computationally efficient manner.

Conventional systems for object querying, such as those used to support web search engines, suffer from various drawbacks. For example, conventional systems accept only short queries such as small numbers of keywords manually selected by users. In contrast, techniques and mechanisms described herein provide for full object querying. In executing a given query, a query data object can be compared with tens or hundreds of millions of corpus data objects. For example, rather than employing a limited set of keywords to formulate a query, a query can instead be based on one or more lengthy text documents having a total of hundreds, thousands, or tens of thousands of pages.

Many conventional systems for object querying classify data objects along a limited set of categories. For example, latent semantic analysis, semantic gist analysis, topic modeling, and latent Dirichlet allocation identify objects as having membership in a limited number of categories. Such techniques can work well for classifying objects associated with limited amount of data, such as a short text snippet. Further, such techniques simplify the computational workload associated with proximity calculations. However, such techniques produce poor results when used to identify proximity between documents associated with large amounts of data, such as lengthy business, legal, technical, or financial documents. That is, conventional techniques based on simplified vectors that reflect categorical classifications typically fail to find the most proximate data objects.

In contrast, techniques and mechanisms described herein support full object querying along many different dimensions. Each corpus object as well as the query data object itself can be associated with thousands or millions of different properties or characteristics. When comparing the query data object vector to tens or hundreds of millions of different corpus objects vectors, the execution of a single query can involve potentially hundreds of trillions of individual unidimensional comparisons. In some embodiments disclosed herein, such a query can be executed in real time or near-real time.

Many conventional systems for object querying return as a result set a lengthy list of result items. For example, a keyword search in a web search engine returns a seemingly infinite list of websites, sorted based on any of various factors. In contrast, techniques and mechanisms described herein provide for a user interface in which query results are represented in a navigable spatial framework presented in a graphical user interface. Using this framework, the relationship of the query data object to corpus data objects may be rendered visually comprehensible.

Many conventional systems graphically position objects in a 2-dimensional space with unitless dimensions, such a space produced by applying multidimensional scaling (MDS) to a vector space. However, collapsing a high-dimensional space to a unitless two-dimensional representation loses most of the important information and produces a representation that is highly sensitive to small changes in the input data. In contrast, according to various embodiments described herein, the temporal-proximity framework described herein is an integral part of the system that allows the accurate and comprehensible representation of the query results. By positioning object representations in a two-dimensional non-Cartesian coordinate system having both distance and time dimensions, a query object may be presented relative to corpus objects in a manner that illustrates the newness of the query object in a dimensionless sense.

Many conventional object query systems ignore object timing. For example, a keyword search in a web search engine may allow a user to restrict results based on some temporal dimension associated with the queried objects. However, the presentation of query results in conventional object query systems do not reflect the timing of the query data object relative to the queried data objects. In contrast, techniques and mechanisms described herein provide for a navigable user interface that supports a temporal-spatial representation of the query data object relative to the most proximate query results.

Many conventional systems for object querying treat every dimension as equivalent. For example, manual keyword searching does not allow a query entrant to specify which keywords are most important. In contrast, techniques and mechanisms described herein provide for the automatic identification of object data characteristic weighting. By automatically evaluating object data to determine which of the hundreds of thousands or millions of dimensions provide for improved proximity determination, query evaluation is made more accurate.

In particular embodiments, one advantage of techniques and mechanisms described herein is the efficient utilization of computing resources given the particular constraints of a distributed query system arranged in whole or in part as discussed herein. For example, the execution of a query may involve potentially trillions of comparisons made across potentially tens or hundreds of millions of vectors. Accordingly, although each node may be capable of handling portions of the computation load associated with many different queries, potentially in parallel within the node, the computation of the result set for an individual query may itself be distributed across many different nodes. By distributing jobs as described herein, aggregate system resource utilization may be reduced while at the same time allowing for rapid execution of proximity queries in a complex proximity model.

In particular embodiments, one advantage of techniques and mechanisms described herein is the efficient utilization of computing resources given the particular constraints of a distributed query system arranged in whole or in part as discussed herein. For example, if too many nodes are available, then the system may represent an inefficient usage of computing resources by maintaining active but under-utilized nodes. If instead too few nodes are available, then the speed of query execution may be reduced.

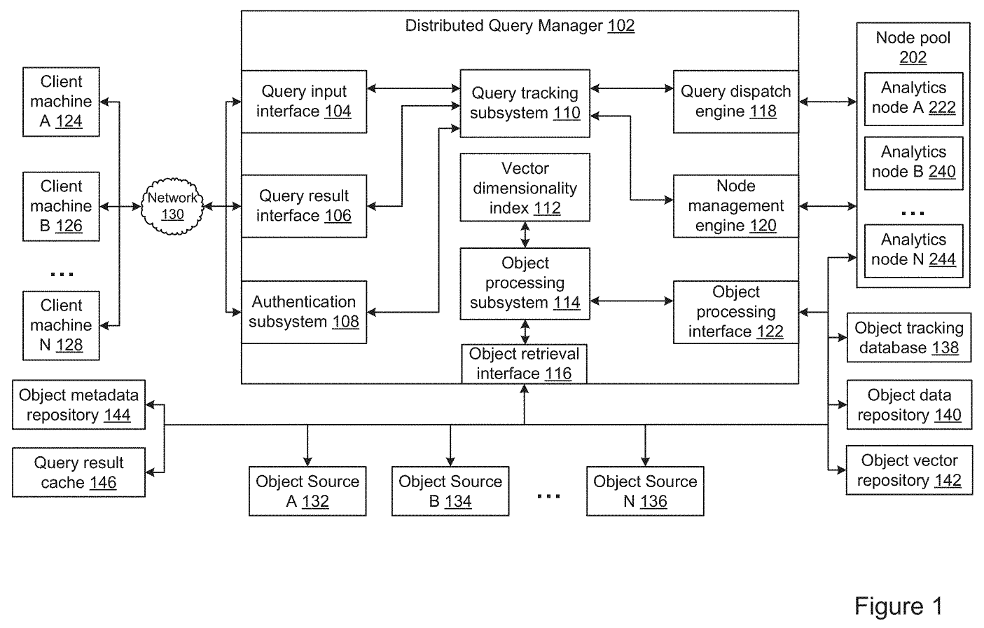

FIG. 1 illustrates an example of a distributed query system that may be used in conjunction with techniques described herein and is configured in accordance with one or more embodiments. The distributed query system shown in FIG. 1 may allow for the identification, retrieval, storage, and vectorization of corpus objects from a variety of object sources. The distributed query system may also allow for the querying of the retrieved and vectorized corpus objects by users associated with client machines.

According to various embodiments, the term “data object” as used herein refers to any discrete and self-contained unit of data. In some embodiments, a data object includes one or more text documents. For example, a data object may represent a book, academic article, magazine article, or newspaper article. As another example, a data object may represent a white paper, technology description, invention disclosure document, financial report, IPO prospectus, legal contract, or other such document associated with a company. As yet another example, a data object may represent a foreign or domestic patent application, patent publication, or issued patent. As still another example, a data object may represent a person, company, or other entity. In particular embodiments, a data object may represent a collection of other data objects.

According to various embodiments, a data object may be associated with both primary data and metadata. For example, a document such as a book or article is associated with primary data represented by the document text. At the same time, such a document is also often associated with metadata such as a publication date, an author, and a publisher. Similarly, an issued patent or patent application includes primary data in the form of the patent text, while at the same time is also associated with metadata such as inventors, filing date, publication date, and issue date.

In some implementations, data objects may be retrieved from any of a variety of external data sources such as object source A 132, B 134, and N 136. For example, a data source may include a database of public financial documents such as the EDGAR database of SEC filings provided by the U.S. Security and Exchange Commission or the initial public offerings (IPO) database provided by the Kauffman foundation. As another example, a data source may include a location for retrieving patent documents such as the searchable U.S. Patent and Trademark database or Google Patents. As yet another example, a data source may include a location for retrieving books or articles such as Google Scholar, Google Books, The Social Science Research Network, JSTOR Journal Storage, or another such website. As yet another example, a data source may include news articles or press releases.

In some implementations, the term “data object” may encompass both “query data objects” and “corpus data objects.” A corpus data object is an object identified, retrieved, and vectorized by the system for the purpose of being searched. A query data object is an object identified in a query that is used to search the corpus. For example, an academic article may be used as a query data object to search a corpus of millions of different academic articles. As another example, a patent application or invention disclosure statement may be used as a query data object to search a corpus of millions of different patents and patent publications.

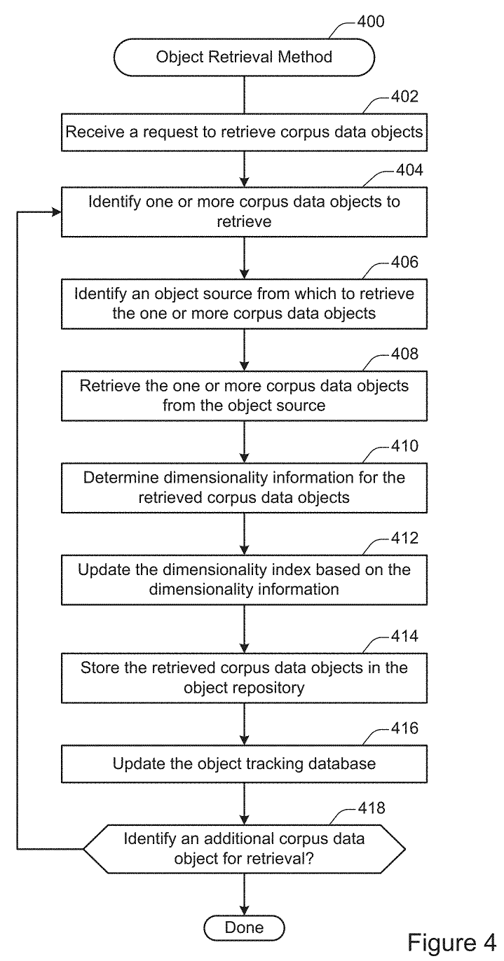

The distributed query manager 102 includes several components related to object processing, such as the vector dimensionality index 112, the object processing subsystem 114, the object retrieval interface 116, and the object processing interface 122. According to various embodiments, the object processing components may collectively perform a variety of tasks related to establishing information about objects that may be queried. For example, the object processing subsystem 114 may keep a record of types and sources of data objects and periodically instruct the object retrieval interface 116 to initiate object retrieval. Techniques for object retrieval are discussed in additional detail with respect to FIG. 4.

According to various embodiments, the object retrieval interface 116 may perform operations such as communicating with object sources to identify objects for retrieval. The object retrieval interface 116 may in some instances retrieve objects directly. Alternately, or additionally, the object retrieval interface 116 may communicate with one or more nodes in the node pool to instruct those nodes to retrieve objects. For example, in the case of a document repository such as the SEC EDGAR database or the USPTO patent database, the object retrieval interface 116 may instruct one or more nodes in the node pool to connect with the database and retrieve a designated set of documents for storage.

In particular embodiments, the object retrieval interface 116 may communicate with an object tracking database 138 to track the status of each object within the distributed query system. For example, an entry in the object tracking database 138 may include a unique identifier associated with each object in the corpus. Then, each object may be associated with status information that indicates, for instance, that the object has not yet been retrieved, has been retrieved but not yet vectorized, as been retrieved and vectorized, or cannot be retrieved due to missing or corrupt data.

In some embodiments, the object data repository 140 may be used to store primary object data associated with retrieved objects. For example, document text associated with retrieved documents may be stored in the object data repository. In some configurations, the full primary data associated with retrieved data objects need not be maintained after vectorization. However, because objects may be re-vectorized after updates are made to the vector dimensionality index 112 based on subsequently retrieved data objects, the continued storage of retrieved data objects may provide for increased query accuracy and system efficiency.

According to various embodiments, the object metadata repository 144 may be used to store object metadata. For example, upon retrieving an object, metadata may be identified directly from the primary data associated with the object or may be retrieved from a different location such as the object source.

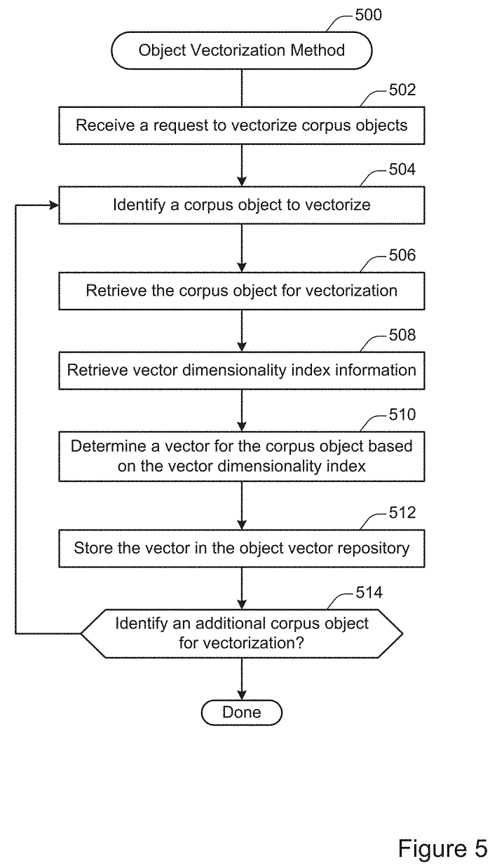

In some implementations, objects may be vectorized during or after object retrieval. Object vectorization may be performed at least in part by the object processing interface 122 under the direction of the object processing subsystem 114. For example, the object processing subsystem 114 may instruct the object processing interface 122 to vectorize all objects that have not yet been vectorized. The object processing interface 122 may then communicate with the object tracking database 138 to identify objects in the corpus that have not yet been vectorized. Then, the object processing interface 122 may communicate with analytics nodes in the node pool 202 to vectorize each object. For instance, each of potentially many different nodes in the node pool may be instructed to vectorize a designated subset of the objects. Techniques for object vectorization are discussed in further detail with respect to FIG. 5.

According to various embodiments, vectorization may involve the construction, updating, and application of the vector dimensionality index 112, discussed in greater detail with respect to FIG. 5. In general, the vector dimensionality index 112 arises by identify individual dimensions from the primary data or metadata associated with objects. For example, a dimension may be a word, a combination of words, or a phrase that appears in a document. The vector dimensionality index may not only identify such dimensions, but may also include other information about the dimension. For example, the vector dimensionality index 112 may indicate the prevalence of the dimension across the pool of objects, such as the number of objects that exhibit the dimension to some degree. As another example, the vector dimensionality index 112 may indicate a weighting of the dimension for the purpose of query execution. Vectors constructed from objects may be stored in the object vector repository 142. From there, the vectors may be retrieved from nodes in the node pool to support query execution.

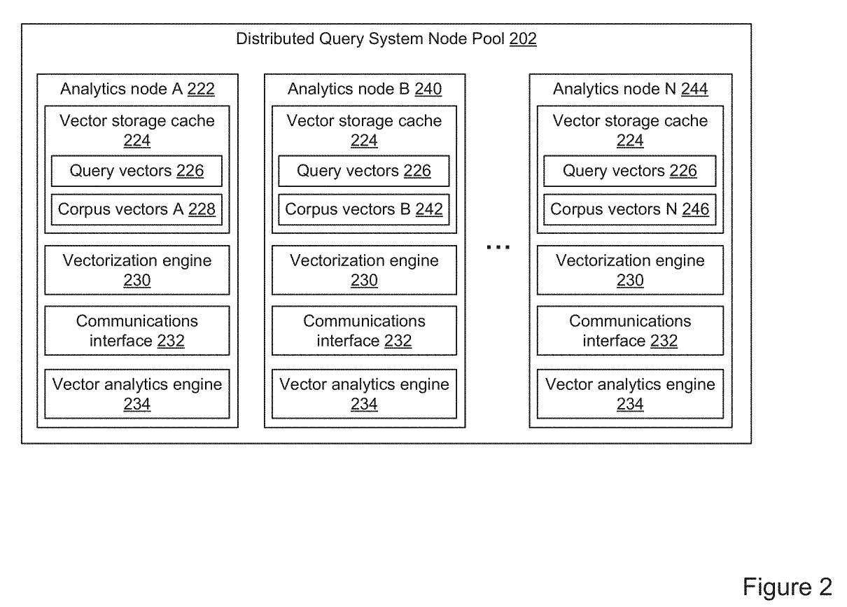

The distributed query system shown in FIG. 1 also includes a node pool 202. The node pool includes a number of analytics nodes, such as the node A 222, the node B 240, and the node N 244. The node pool is discussed in greater detail with respect to FIG. 2. According to various embodiments, each node in the node pool includes computing hardware and software for performing various operations related to query processing and/or object retrieval and processing. For example, a node may be configured to retrieve, store, vectorize, and query a designated subset of the data objects tracked by the system.

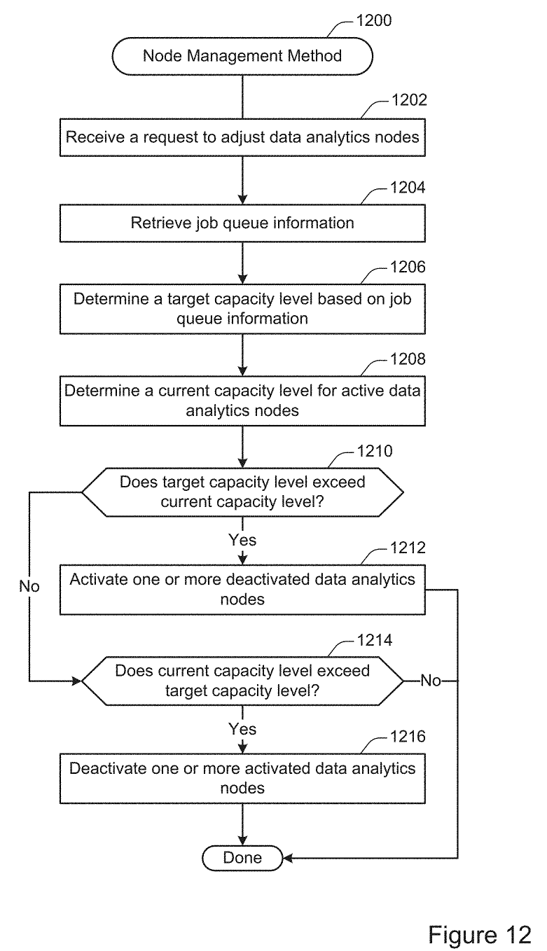

In some embodiments, nodes are managed by the node management engine 120, which performs operations such as scaling the number of active nodes up or down based on factors such as query load and object retrieval and processing load. Techniques for node management are discussed in additional detail with respect to the method 1200 shown in FIG. 12.

The distributed query system includes a distributed query manager 102 that may perform any of a variety of tasks related to query management. The distributed query manager 102 includes several components related to query processing, such as the query input interface 104, the query result interface 106, the query tracking subsystem 110, the query dispatch engine 118, and the authentication subsystem 108.

According to various embodiments, the authentication subsystem 108 is configured to communicate with the client machines A 124, B 126, and N 128 via the network 130 to authenticate an account. For example, querying may be limited to particular customer accounts, and each customer account may be identified via authentication information such as a username and password.

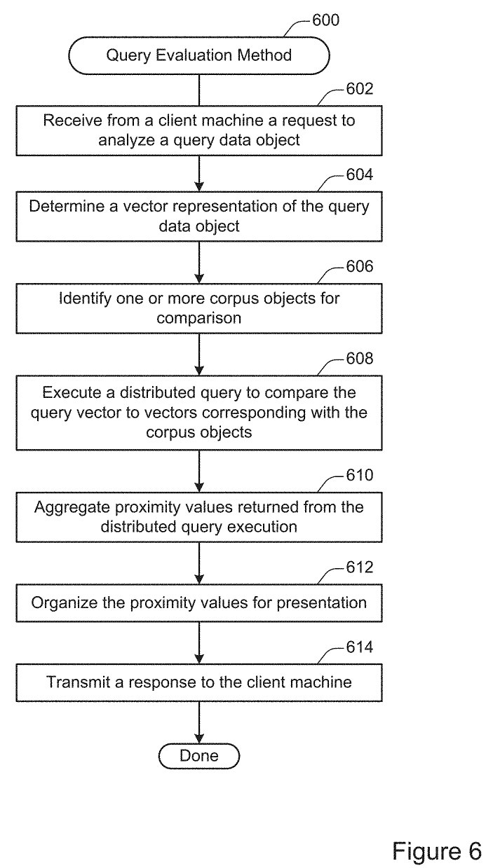

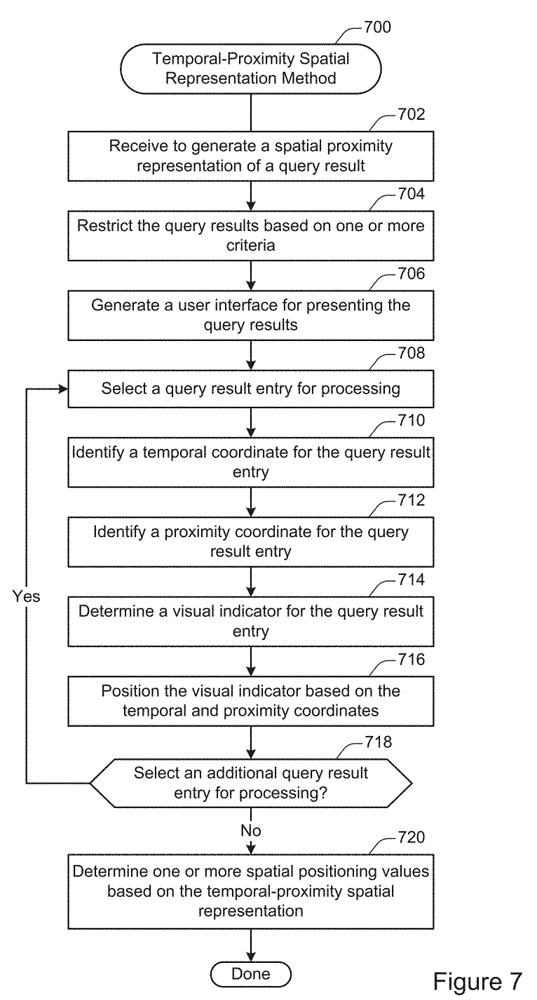

In some embodiments, the query input interface 104 is configured to receive query input information from the client machines via the network, while the query result interface 106 is configured to provide query results to the client machine. Techniques for receiving and evaluating queries are discussed in further detail with respect to FIG. 6. Techniques for providing query results to client machines are discussed in further detail with respect to both FIG. 6 and FIG. 7.

In some implementations, the query tracking subsystem 110 is configured to track information about each query received by the system. For example, the query tracking subsystem 110 may store information about each query in a database, such as the user account associated with the query, the content of the query, any parameters associated with the query, the time at which the query was received, the time at which the query was executed, and other such information.

According to various embodiments, the query dispatch engine 118 is configured to retrieve query information from the query tracking subsystem 110 and to organize the execution of the query among the nodes in the node pool. For example, the query dispatch engine 118 may split the objects to be queried into subsets and then assign different subsets to different nodes.

In particular embodiments, some or all of the query results may be stored in the query result cache 146. For example, the query result cache may store results such as proximity values between the query object and one or more of the corpus data objects. As another example, the query result cache may store results such as proximity values computed between corpus data objects that are not the subject of a query, as such proximity values may be used to facilitate the positioning of the query object in a spatial representation of the result set.

According to various embodiments, one or more of the components shown in FIG. 1 may be implemented in a scalable, on-demand computing environment. For example, one or more components may be implemented as a standardized Docker or Kubernetes container implementable on any system that supports such an interface. As another example, one or more components may be implemented as a compute node or application node running on an infrastructure such as Microsoft Azure, Google Cloud, or Amazon Web Services.

In particular embodiments, the distributed query system shown in FIG. 1 may have components arranged in a different fashion. For example, the query tracking subsystem 110 is shown as being included in the distributed query manager 102. However, in some embodiments, the query tracking subsystem 110 may include a query database located outside the distributed query manager. As another example, the query processing components are shown in FIG. 1 as being included in the same distributed query manager as the object processing components. However, in some embodiments, query processing operations may be located in one distributed query manager, while object processing operations may be located in a different distributed query manager.

FIG. 2 illustrates an example of a distributed query system node pool 202 that may be used in conjunction with techniques described herein and is configured in accordance with one or more embodiments. As discussed with respect to FIG. 1, the distributed query system node pool 202 includes potentially many different analytics nodes, include the nodes A 222, B 240, and N 244. Each node includes a vector storage cache 224, which can store query vectors 226 and/or corpus vectors such as the vectors A 228, B 242, and N 246. Each analytics node also includes a vectorization engine 230, a communications interface 232, and a vector analytics engine 234.

According to various embodiments, each analytics node may be directed to perform any of several different analytics tasks for the distributed query system. For example, a node may be tasked with retrieving objects from an object source such as the object source A 132. The object may be stored in the object data repository 140, and information about the object may be stored in the object tracking database 138 and/or the object metadata repository 144. Techniques for object retrieval are discussed in further detail with respect to the method 400 shown in FIG. 4.

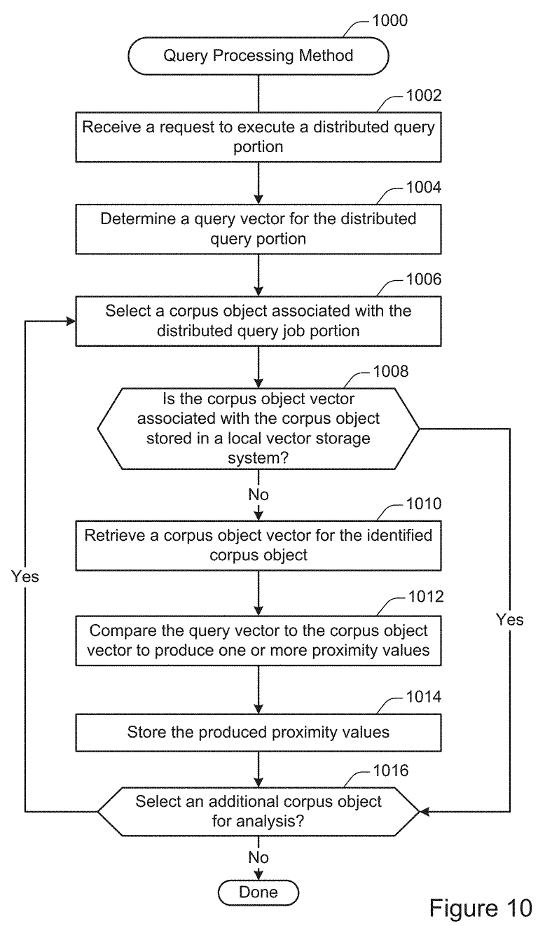

As another example, a node may be tasked with creating an object vector for each of a set of corpus objects and storing the object vectors in the object vector repository 142. Techniques for object vectorization are discussed in further detail with respect to the method 500 shown in FIG. 5. As yet another example, a node may be tasked with executing all or a portion of a distributed query. Techniques for query execution are discussed in further detail with respect to the method 600 shown in FIG. 6 as well as the method 1000 shown in FIG. 10.

According to various embodiments, the vector storage cache 224 may store vectors created at the analytics node, for instance by the vectorization engine 230. Alternately, or additionally, the vector storage cache 224 may store vectors retrieved from the object vector repository 142. The vector storage cache 224 may be implemented in temporary memory, a non-temporary storage device, or a combination thereof. In particular embodiments, the vector storage cache 224 may function as a cache for performing vector-based data analytics operations at the data analytics node. In addition to storing the vectors themselves, the vector storage cache 224 may include an index for identifying and accessing vectors stored in the system.

According to various embodiments, the vectorization engine 230 may be configured to perform various operations related to representing the retrieved data object as a vector. For example, the vectorization engine 230 may analyze data associated with objects and use the analysis to update the vector dimensionality index 112. As another example, the vectorization engine 230 may compare data associated with the retrieved data object with the vector dimensionality index to determine a vector representation for the data object.

According to various embodiments, the communications interface 232 may be responsible for performing operations such as communicating with the query dispatch engine 118, with external object data sources, with internal repositories, caches, or databases, or other such system components.

According to various embodiments, the vector analytics engine 234 may perform any of various analytics operations, for example as will be discussed with respect to FIGS. 6 and 10. In particular, the vector analytics engine 234 may be configured to compare one or more query vectors with potentially many different corpus object vectors to determine a proximity value between each pair of vectors.

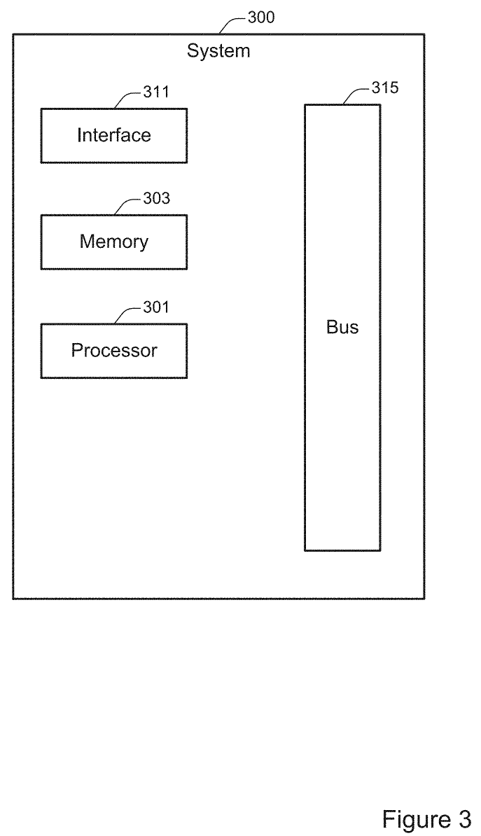

FIG. 3 illustrates one example of a server that may be used in conjunction with techniques described herein and is configured in accordance with one or more embodiments. According to particular embodiments, a system 300 suitable for implementing particular embodiments of the present invention includes a processor 301, a memory 303, an interface 311, and a bus 313 (e.g., a PCI bus or other interconnection fabric). When acting under the control of appropriate software or firmware, the processor 301 is responsible for implementing applications such as query processing, object retrieval, and object vectorization. Various specially configured devices can also be used in place of a processor 301 or in addition to processor 301. The interface 311 is typically configured to send and receive data packets or data segments over a network, such as a private network and/or the internet.

Particular examples of interfaces supported include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control communications-intensive tasks such as packet switching, data control, and data management.

According to various embodiments, the system 300 is a data analytics node. For example, the system 300 may perform tasks such as object retrieval, object vectorization, and object query execution. In particular embodiments, the system 300 may execute a portion of a distributed query that applies to a designated set of objects.

According to various embodiments, one or more methods described herein may be implemented entirely or in part on the system 900. Alternately, or additionally, one or more methods described herein may be embodied entirely or in part as computer programming language instructions implemented on one or more non-transitory machine-readable media. Such media may include, but are not limited to: compact disks, spinning-platter hard drives, solid state drives, external disks, network attached storage systems, cloud storage systems, system memory, processor cache memory, or any other suitable non-transitory location or locations on which computer programming language instructions may be stored.

FIG. 4 illustrates an example of an object retrieval method, performed in accordance with one or more embodiments. According to various embodiments, the method 400 may be performed at a data analytics node. For example, each of potentially many different data analytics nodes may be sent an instruction to retrieve a respective subset of corpus data objects. Corpus data objects may be retrieved and processed so that they may be incorporated into the search pool and be the subject of proximity searches.

At 402, a request to retrieve corpus data objects is received. According to various embodiments, the request may be generated by the object retrieval interface 116. At 404, the data analytics node identifies one or more corpus data objects to retrieve. In some implementations, the retrieval request received at operation 402 may indicate specific objects to retrieve. Alternately, the retrieval request may indicate a range of identifiers or some other information that may be used by the data analytics node to identify objects for retrieval. In particular embodiments, each data analytics node may be pre-assigned a particular range, category, or subset of corpus data objects to retrieve upon request.

At 406, an object source from which to retrieve the one or more corpus data objects is identified. In some implementations, the data source from which to retrieve the objects may depend on the type of data object being retrieved. For example, when retrieving academic articles, a website such as JSTOR or SSRN may be used as the source of the articles. As another example, when retrieving patents or patent publications, an interface such as the searchable USPTO database or Google Patents may be used.

At 408, the one or more corpus data objects are retrieved from the object source. In some embodiments, the corpus data objects may be retrieved via standard retrieval mechanisms such as file downloading operations that download files to memory or a storage location associated with the data analytics node.

At 410, dimensionality information is determined for the retrieved corpus data objects. According to various embodiments, the determination of the dimensionality may depend on the type of proximity model used to evaluate the proximity between two data objects. At 412, the dimensionality index is updated based on the dimensionality information determined at operation 410. Updating the dimensionality involve storing, transmitting, and/or aggregating information such as dimensional identifiers, dimensional frequencies, and dimensional weights. For example, each data analytics node may communicate information to the object processing subsystem 114, which may aggregate these various inputs to produce and/or update the vector dimensionality index 112. As another example, the vector dimensionality index 112 may be stored at a location such as a database that may be directly accessed by the analytics nodes, which may then update the dimensionality index directly.

In some embodiments, proximity may be determined via a term frequency-inverse document frequency (TFIDF) model. In information retrieval, TFIDF is a numerical statistic that is intended to reflect how important a word is to a document in a collection or corpus. The TFIDF value increases proportionally to the number of times a word appears in the document, but is often offset by the frequency of the word in the corpus, which helps to adjust for the fact that some words appear more frequently in general. In a TFIDF approach, the dimensionality index may include each word that appears in any document included in a corpus data object. The dimensionality index may also indicate the number of documents in which each word occurs. Thus, after vectorization, the weight of a term that occurs in a document may be proportional to both the term frequency in the document and an inverse function of the number of documents in which it occurs. Similar schemes may also be used, including Term Frequency Proportional Document Frequency.

At 414, the retrieved corpus data objects are stored in the object repository. In some embodiments, storing the objects in the repository may involve, for instance, uploading the objects to a cloud computing storage bucket or a dedicated network-accessible storage location. Alternately, objects may be downloaded directly from the object source to such a storage location.

At 416, the object tracking database is updated. In some implementations, updating the object tracking database may involve performing operations such as inserting or updating a database entry that identifies a retrieved object. Such an entry may also include corpus object status information, for instance indicating that the object has been retrieved.

At 418, a determination is made as to whether to identify additional corpus data objects for retrieval. According to various embodiments, additional corpus data objects may be retrieved until all or substantially all of the corpus data objects assigned to the data analytics node for retrieval have been retrieved.

FIG. 5 illustrates an example of an object vectorization method, performed in accordance with one or more embodiments. According to various embodiments, the method 500 may be performed at a data analytics node in communication with a distributed query system. The method 500 may be performed in order to evaluate the data object in such a way as to support efficient and accurate query execution against the object and to thereby fully incorporate the data object into the corpus of queryable data objects.

At 502, a request to vectorize corpus objects is received. According to various embodiments, the request may be generated by the object processing interface 122. At 504, the data analytics node identifies a corpus data objects to vectorize. In some implementations, the retrieval request received at operation 502 may indicate specific objects to vectorize. Alternately, the retrieval request may indicate a range of identifiers or some other information that may be used by the data analytics node to identify objects for vectorization. In particular embodiments, each data analytics node may be pre-assigned a particular range, category, or subset of corpus data objects to vectorize when requested to begin vectorization.

At 506, the corpus object is retrieved for vectorization. According to various embodiments, retrieving the corpus object may involve communicating with the object data repository 140. Alternately, a copy of the corpus object may already be stored on the data analytics node. For example, in some embodiments object retrieval may be combined with object vectorization, so that objects are vectorized upon retrieval.

At 508, vector dimensionality index information is retrieved. According to various embodiments, the vector dimensionality index information may be retrieved from the vector dimensionality index 112 shown in FIG. 1. The vector dimensionality information may include any information necessary for producing a representative vector from the object data. For example, in the case of TFIDF proximity analysis, the vector dimensionality information may indicate the frequency with which each term that occurs in the object data occurs in other documents within the corpus. As another example,

At 510, a vector is determined for the corpus object based on the vector dimensionality index. According to various embodiments, each vector may include a value for each dimension included in the vector dimensionality index. For example, a dimension in the vector may correspond with a term that appears in a text document, a topic that appears in a topic model, or some other such characteristic.

In some embodiments, the procedure employed for determining the vector may depend largely on the type of proximity model employed. For example, in the case of TFIDF proximity analysis, the vector may be determined by assigning a value to each term that is included in the vector dimensionality index. If a given term does not appear in the text associated with the corpus document, then the term may be given a value of zero. If a given term does appear in the text associated with the corpus document, then the term may be given a value that is related to both the frequency with which the term appears in the text of the corpus document and the frequency with which the term appears in the corpus at large. The precise formula for assigning dimensional value may be strategically determined based on factors such as characteristics of particular object types. However, in general the weighting of a dimension for a particular term will increase as the frequency of the term within the corpus document increases and will decrease as the frequency of the term across the corpus increases.

In particular embodiments, some values may not be stored for at least some vectors. For example, if a particular dimension is assigned a value of zero for a particular corpus object, then the value may be omitted when creating and/or storing the vector. In this way, objects may be assigned values for each dimension in a multi-dimensional vector space that includes hundreds of thousands or millions of dimensions while at the same time storing such vectors in a computational and space efficient manner.

At 512, the vector is stored in the object vector repository. For example, the object vector repository 142 may be implemented as a storage location in an on-demand cloud computing environment. As another example, the object vector repository 142 may be implemented as a storage location in a network-attached storage location.

At 514, a determination is made as to whether to identify additional corpus data objects for vectorization. According to various embodiments, additional corpus data objects may be identified for vectorization until all or substantially all of the corpus data objects assigned to the data analytics node for vectorization have been vectorized.

According to various embodiments, the operations performed in FIG. 5 may be performed in an order different than that shown. For example, corpus objects may be retrieved and/or vectorized in parallel rather than in serial. As another example, corpus vectors may be stored in a batched or parallel fashion rather than immediately upon the creation of each corpus vector.

FIG. 6 illustrates an example of a query evaluation method, performed in accordance with one or more embodiments. According to various embodiments, the method 600 may be performed at a distributed query manager 102.

At 602, a request is received from a client machine to analyze a query data object. According to various embodiments, the request may be received from one of the client machines 124, 126, and 128 shown in FIG. 1. In some instances, the request may include a query data object for querying. For example, the request may include one or more documents or other such object data. Alternately, or additionally, the request may indicate a query data object to query. For example, the request may include a document identifier (e.g., a patent number, SEC filing number, academic article identifying information, etc.). In some instances, the query data object may be a corpus data object. Alternately the query data object may be a new object that was not previously known to the distributed query manager.

At 604, a vector representation of the query data object is determined. According to various embodiments, the process for determining a vector representation may be substantially similar to the procedure for vectorizing corpus data objects. For example, the query data object may be received with the request at operation 602 or may be retrieved as discussed with respect to the method 400 shown in FIG. 4. Then, the query object data may be vectorizes substantially as discussed with respect to the method 500 shown in FIG. 5.

At 606, one or more corpus objects are identified for comparison. According to various embodiments, corpus objects may be identified based at least in part on the request received at operation 602. For example, the request may indicate a particular set of corpus objects to search, which may include some or all of the total available corpus objects. As another example, the request may indicate one or more criteria for selecting corpus objects to search. In some embodiments, corpus objects may be identified by applying selection criteria to the retrieval of corpus object information from the object tracking database 138.

At 608, a distributed query is executed to compare the query vector to vectors corresponding with the corpus objects. Techniques for executing a distributed query vector are discussed in additional detail with respect to the method 1000 shown in FIG. 10.

At 610, proximity results returned from the distributed query execution are aggregated. According to various embodiments, aggregating the proximity results may involve retrieving a subset of the total proximity results from a database or repository such as the query result cache 146. For example, as discussed with respect to FIG. 7, a proximity result may be included in the aggregation when the proximity result meets a designated criterion, such as when the proximity value associated with the result exceeds a designated threshold.

At 612, the proximity values are organized for presentation. According to various embodiments, the organization of proximity values for presentation may involve operations such as the construction and provision of a user interface in which to present the proximity values. For example, such a user interface may be provided via a dynamic webpage or an application running on the operating system of the client machine. As another example, proximity values may be arranged graphically in a format that is provided to the client machine in a static report such as a document. Such a document may be transmitted via email, direct download, or any other suitable transmission mechanism.

At 614, the response is transmitted to the client machine. According to various embodiments, transmitting the response to the client machine may involve any suitable operation for conveying some or all of the query results. For example, a message such as an HTTP response or an email may be transmitted to the client machine. The message may include a static interface such as a list of query results and/or a temporal-spatial representation included in a static document such as a PDF file. Alternately, or additionally, the message may include information for accessing a dynamic user interface that includes such as a temporal-spatial representation. For instance, the message may provide a website with such a user interface or may provide information for generating the representation in an application running at the client machine.

FIG. 7 illustrates an example of a temporal-proximity spatial representation method, performed in accordance with one or more embodiments. According to various embodiments, the method 700 may be performed at a component such as the query result interface 106 shown in FIG. 1. The method 700 may be performed in order to provide the query results to the client machine in an interpretable and useful fashion.

At 702, a request to generate a temporal-proximity representation of a query result is received. According to various embodiments, the request may be automatically generated when a query result is returned. For example, when the last of the data analytics nodes associated with computing a query result have completed calculations, the distributed query manager 102 may transmit a request to generate the temporal-proximity representation.

At 704, the query results are restricted based on one or more criteria. According to various embodiments, the query results may include proximity values for potentially millions or hundreds of millions of different objects. However, many of the objects may be irrelevant according to one or more criteria. For example, many corpus objects may have proximity values indicating that they are relatively distant from the query object. As another example, some corpus objects may be relatively duplicative. The proximity values for such corpus objects may be excluded from the initial graphical representation.

In some embodiments, the precise number of query results to exclude from the temporal-spatial representation may depend at least in part on factors such as the size afforded to the graphical user interface, the number of highly-proximate data objects identified by the query, and/or one or more configuration parameters. For example, a user may request to receive query results at a particular level of granularity. In one implementation, the number of query results presented may range between 5 and 100. However, smaller or larger numbers of query results are also possible.

At 706, a user interface is generated for presenting the query results. According to various embodiments, a graphical user interface may be provided via a dynamically generated website. Alternately, or additionally, a graphical user interface may be provided via a stand-alone application in communication with the distributed query system.

In some implementations, the user interface may provide various types of interaction with the query results. For example, users may be able to present, select, organize, or filter lists of query results according to user-specified criteria. As another example, users may be presented with visual representations of the query results other than the temporal-proximity spatial representation described herein. As yet another example, users may be able to retrieve additional information such as metadata or proximity values associated with corpus and/or query documents.

At 708, a query result entry is selected for processing. According to various embodiments, the query result entries may be selected in any suitable order, and may be analyzed in sequence or in parallel. A query result entry may include various types of information associated with a corpus vector. For example, a query result entry may include a proximity value representing a proximity between the query result vector and the corpus object vector. As another example, a query result entry may include metadata about the associated corpus object itself or the relationship between the corpus object and the query object. For instance, the query result entry may include one or more dates associated with the corpus object. The query result entry may also include information such as linkages (e.g., academic or patent citations) between the query object and the corpus object. The query result entry may also include information such as an entity identifier indicating an entity such as a company or individual associated with the corpus object.

At 710, a temporal coordinate is identified for the query result entry. According to various embodiments, the temporal coordinate may be identified based on metadata associated with the corpus data object for which the query result identifies a proximity value. The temporal coordinate may be identified based on any relevant temporal characteristic. For example, when the corpus data object represents an academic article, the temporal coordinate may be the publication date associated with the article. As another example, when the corpus data object represents a patent or patent publication, the temporal coordinate may be the priority date, application filing date, or patent issue date associated with the patent or publication. As yet another example, when the corpus data object represents technical, legal, or business document, the temporal coordinate may be the publication date associated with the document. In some embodiments, the temporal coordinate may be identified based on information retrieved from the object metadata repository 144.

At 712, a proximity coordinate is identified for the query result entry. According to various embodiments, the proximity coordinate may be identified by scaling or otherwise processing the proximity value returned for the relevant data object by the query execution. For example, when used to position a visual indicator such as a corpus point in the temporal-proximity spatial representation, the proximity value may be scaled between zero and one such that a proximity of one indicates that the two data objects are identical or nearly identical. When the proximity value is drawn from such a scale, the proximity coordinate may be set as the proximity value subtracted to one, in order for the proximity coordinate to represent a distance between the query data object and the corpus data object in the vector space. Of course, various other scalings are possible.

At 714, a visual indicator for the query result entry is determined. According to various embodiments, the visual indicator may be any object suitable for inclusion in the temporal-proximity spatial representation for representing the data object associated with the query result. For example, the visual indicator may be a point, a circle, a square, a triangle, or any other shape.

In particular embodiments, the nature of the visual indicator may reflect one or more characteristics of the data object. For example, if a data object represents an issued patent or published patent application, then the shape of the visual indicator may correspond to a data feature such as the identity of the assignee. According to various embodiments, the visual indicators may vary in characteristics such as shape, outline color, fill color, and size, all of which may correspond to properties or characteristics of the data object.

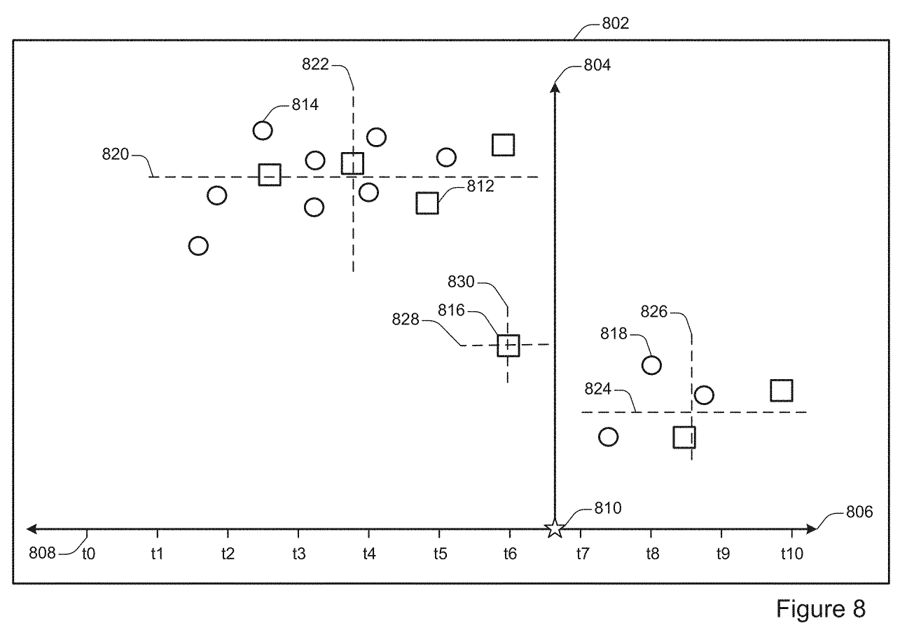

At 716, the visual indicator is positioned based on the temporal and proximity coordinates. According to various embodiments, the visual indicator may be positioned as discussed with respect to FIG. 8. That is, the visual indicator may be positioned within a coordinate system wherein one axis corresponds with the temporal coordinate and the other axis corresponds with the proximity coordinate.

At 718, a determination is made as to whether to select an additional query result entry for processing. According to various embodiments, additional query result entries may be identified for vectorization until all or substantially all of the query result entries have been processed.

In particular embodiments, the operations performed in FIG. 7 may be performed in an order different than that shown. For example, query result entries may be processed in parallel rather than in serial.

At 720, one or more spatial positioning values are determined based on the temporal-proximity spatial representation. According to various embodiments, various types of spatial positioning values may be determined. For example, an Originality value may be determined by finding a statistical average of the distance values (i.e. the proximity coordinates) for d corpus ata objects included in the spatial representation that occur prior to the query data point. Such a value may provide an indication of how original the query data object is in comparison to earlier-occurring corpus data objects.

As another example, a Legacy value may be determined by finding a statistical average of the proximity values (i.e. the inverse of the distance values) for corpus data objects included in the spatial representation that occur later than the query data point. Such a value may provide an indication of the extent to which the query data object was followed by similar corpus data objects.

As yet another example, a Latency value may be determined by finding a statistical average of the temporal coordinates for corpus data objects included in the spatial representation that occur prior to the query data point. Such a value may provide an indication of the timing of the query data object relative to prior corpus data objects.

As yet another example, a Continuity value may be determined by finding a statistical average of the temporal coordinates for corpus data objects included in the spatial representation that occur later than the query data point. Such a value may provide an indication of the timing of the query data object relative to subsequent corpus data objects.

As yet another example, a Novelty value may be determined by finding a minimum proximity coordinate (i.e. distance value) for corpus data objects included in the spatial representation that occur earlier than the query data point. Such a value may provide an indication of the extent to which the query data object represents a change from the most proximate prior corpus data object.

As yet another example, an Intermittency value may be determined by finding the temporal coordinate for the corpus data object occurring prior to the query data object and having the minimum proximity value for corpus query data objects Such a value may provide an indication of the timing of the query data object relative to the most proximate prior corpus data object.

In some implementations, each of the spatial positioning values discussed above may be computed in any of various ways. For example, input values to the calculations may be scaled to be distance from the query data object rather than absolute values. As another example, the resulting measures may be normalized based on similar calculations across the corpus to produce a measuring having suitable statistical characteristics, such as a z-score having a mean of zero and a standard deviation of one.

In particular embodiments, one or more of the spatial positioning values discussed above may be computed based on proximity values not shown graphically within the temporal-proximity spatial representation. For example, the temporal-proximity spatial representation may depict only 25 of the most proximate corpus data objects, while the spatial positioning values may be determined using 100, 1000, or some other number of the most proximate corpus data objects.

In particular embodiments, one or more of the operations shown in FIG. 7 may be omitted. For example, instead of presenting the temporal-proximity spatial representation within a graphical user interface, the representation may instead be generated as a static or dynamic image and then included in a document such as a PDF file. The document may then be provided to the client machine via email, direct download, or some other transmission mechanism.

FIG. 8 illustrates an example of a user interface including a temporal-proximity spatial representation, provided in accordance with one or more embodiments. The temporal-proximity spatial representation shown in FIG. 8 is presented with a user interface portion 802. As discussed with respect to FIG. 7, various types of user interfaces are possible. However, the user interface portion 802 focuses on the portion of the user interface in which the temporal-proximity spatial representation is provided.

According to various embodiments, the temporal-spatial representation shown in FIG. 8 includes a first axis 806 and a second axis 804. The first axis 806 corresponds to the time dimension. The first axis 806 includes various time indicators, such as the time indicator t0 shown at 808. In various implementations, different time indicators may be used. For example, a time indicator may represent a point in time such as a particular year, month, or day. As another example, a time indicator may indicate a time relative to a fixed point. For instance, a time indicator may indicate a number of days, months, or years before or after a time associated with the query ata object.

According to various embodiments, the second axis 804 corresponds to the distance of the corpus data object from the query data object in the vector space. The distance may be determined by inverting the proximity value. For example, two objects that are more proximate are by definition less distant. In particular embodiments, the second axis 804 is located along the temporal axis at the temporal coordinate associated with the query data object. For example, if the temporal coordinate associated with the query data object is Sep. 5, 2012, then the second axis 804 may intersect the first axis 806 at that point. In this way, corpus objects associated with points located to the right of the second axis 804 are those that are preceded by the query data object in time, while corpus objects associated with points located to the left of the second axis 804 are those that precede the query data object in time.

The temporal-spatial representation shown in FIG. 8 also includes a query data object point 810. According to various embodiments, the query data object point 810 is situated at the origin. Because the proximity distance between the query data object and itself is zero, the coordinate of the query data object point along the distance axis is zero. Similarly, because the temporal distance between the query data object and itself is zero, the temporal coordinate is also zero.

The temporal-spatial representation shown in FIG. 8 also includes several corpus object points, including the corpus object points 814, 816, and 818. According to various embodiments, each corpus object point may correspond to an individual corpus data object. Alternately, a corpus object point may correspond to more than one corpus data object, for instance when several corpus data objects are themselves highly proximate.

According to various embodiments, the position of each p corpus object point may be determined by its temporal and proximity coordinate as described with respect to FIG. 7. Corpus data objects that occur later in time will be positioned to the right of corpus data objects that occur earlier in time. Similarly, corpus data objects that are more distant from the query data object will be positioned above corpus data objects that are less distant from the query data object. For example, the data object corresponding to the corpus object point 814 is both earlier in time and more distant to the query object than the data object corresponding to the corpus object point 818.

The temporal-spatial representation shown in FIG. 8 also includes indicator lines 820, 822, 828, 830, 826, and 824. According to various embodiments, the indicator lines may be included to represent one or more of the positioning values discussed with respect to FIG. 7. For example, the indicator line 820 may be associated with the query document's Originality value. The indicator line 824 may be associated with the query document's Legacy value. The indicator line 826 may be associated with the query document's Continuity value. The indicator line 822 may be associated with the query document's Latency value. The indicator line 828 may be associated with the query document's Novelty value. The indicator line 830 may be associated with the query document's Intermittency value.

Many of the examples discussed herein suggest that a query includes a single query object and that proximity values are determined between corpus objects and this single query object. However, in various embodiments a query may include more than one query object, and proximity values may be determined between corpus objects and multiple query objects. For example, the temporal-spatial representation shown in FIG. 8 may include separate visual indicators for each of multiple query objects, and the proximity coordinate may represent an aggregated proximity between the relevant corpus data object and the multiple query objects.

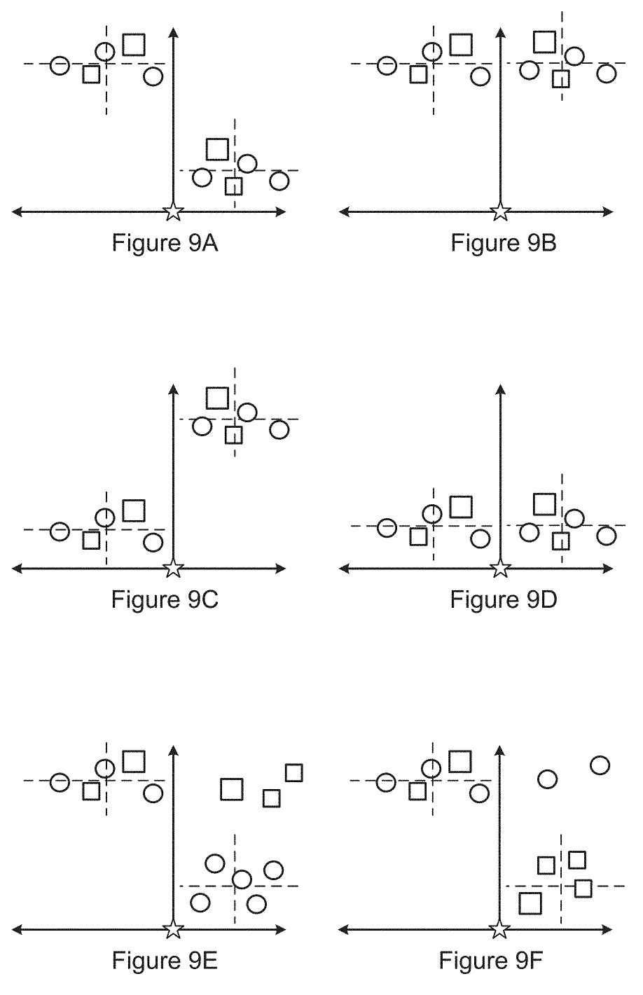

FIGS. 9A-9F illustrates additional examples of a user interface including a temporal-proximity spatial representation, provided in accordance with one or more embodiments. The particular temporal-spatial representation produced will depend on the results returned by the proximity query. Different representations provide different information about the underlying result set and, accordingly, the query object associated with the query object query vector. The examples of the user interface shown in FIGS. 9A-9F illustrate the power of the techniques and mechanisms described herein for making sense of the potentially tens or hundreds of millions of proximity results that may be returned by a single query.

For example, FIG. 9A represents a situation in which the query object is a “first mover”. It is highly distant on average from the closest corpus objects that occurred earlier and is therefore exhibits high originality. However, it is highly proximate to the closest corpus objects that occurred later in time and therefore exhibits high legacy.

FIG. 9B represents a situation in which the query object is “isolated”. The query object is highly distant on average from both the closest corpus objects that occurred earlier in time (i.e. high originality) as well as the closest corpus objects that occurred later in time (i.e. low legacy).

FIG. 9C represents a situation in which the query object is “stale”. The query object is highly proximate on average to the closest corpus objects that occurred earlier in time (i.e. low originality) but is highly distant on average from the closest corpus objects that occurred later in time (i.e. low legacy).

FIG. 9D represents a situation in which the query object is “mature”. The query object is highly proximate on average to the closest corpus objects that occurred earlier in time (i.e. low originality) and is also highly proximate on average to the closest corpus objects that occurred later in time (i.e. high legacy).

FIGS. 9E and 9F represent variations on a “first mover” situation. For example, in the case of technological innovation, the value of a “first mover” technology may depend on whether the owner of the query technology can capitalize on the innovation. In FIG. 9E, the query object is followed by subsequent objects by the same firm (i.e. high within-firm legacy but low outside-firm legacy), indicating a “first mover advantage”. In FIG. 9F, the query object is followed by subsequent objects by a different firm (i.e. low within-firm legacy but high outside-firm legacy), indicating a “first mover failure.”

As shown in FIGS. 8 and 9A-9F, the graphical user interface associated with the parallel query processing system described herein provides a way to easily visualize the query results. For example, a “first mover” object as seen in FIG. 9A may be easily distinguished from a “mature” object as seen in FIG. 9B. Conventional vector results presented in a simple list ordered by, for example, proximity, allow the user to identify corpus objects that are proximate to the subject of the query request. In contrast, the query and user interface techniques disclosed herein allows a user to easily grasp the significance of the object being queried relative to corpus objects. Moreover, by presenting the search results in such a user interface, a user may quick navigate between objects to evaluate the significance of corpus objects in the space.

FIG. 10 illustrates an example of a query processing method 1000, performed in accordance with one or more embodiments. According to various embodiments, the method 1000 may be performed by an individual analytics node in the node pool 202. The method 1000 may be performed in order to process a particular portion of a distributed query.

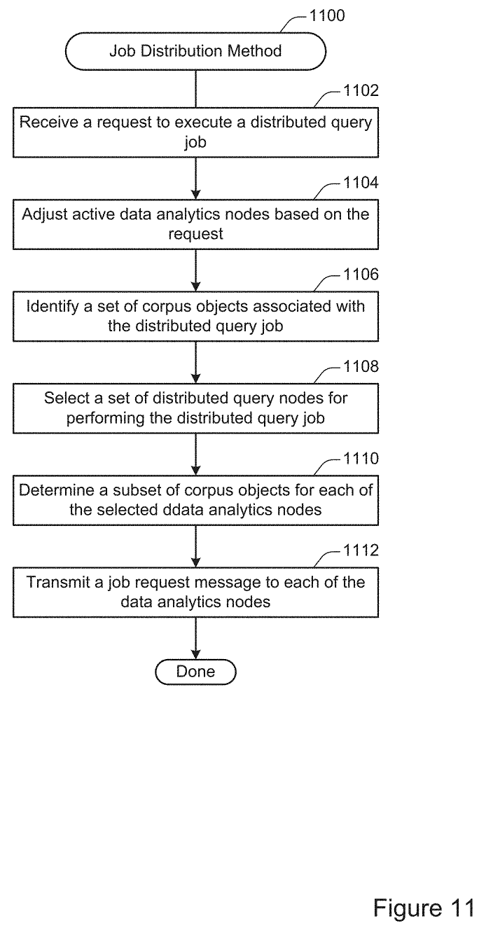

At 1002, a request is received to execute a distributed query portion. According to various embodiments, the request may be generated as part of a job distribution method. An example of a job distribution method is discussed in additional detail with respect to FIG. 11. In some instances, the request may be generated automatically by the node itself. For example, when the node has computing resources available for computation, then the node may automatically communicate with the query tracking subsystem 110 to identify a distributed query portion for execution.

At 1004, a query vectors for the distributed query portion is determined. In some embodiments, a query vector may be included in the request received at operation 1002. Alternately, the request received at operation 1002 may provide an indication about the identity of the focal vector so that the analytics node may retrieve the query vector from an appropriate source, such as the query tracking subsystem 110.

At 1006, a corpus object associated with the distributed query job portion is selected. In some implementations, the corpus objects for which the analytics node is responsible may be specified in the request received at 1002. Alternately, an analytics node may be pre-assigned a set of corpus objects for executing distributed query job portions. Once identified, the corpus objects may be selected for analysis sequentially, at random, all at once, or in any suitable order.

At 1008, a determination is made as to whether the corpus object vector associated with the corpus object is stored in a local vector storage cache such as the system 224 shown in FIG. 2. For instance, the vector storage cache 224 may maintain an index of the corpus vectors stored in the system.

At 1010, a corpus object vector for the identified corpus object is retrieved. In some embodiments, the corpus object vector may be retrieved by communicating with the object vector repository 142 shown in FIG. 1.

At 1012, the corpus object vector is compared to the query vectors to produce a proximity value. According to various embodiments, the nature of the comparison of the query vectors with the corpus object vector will depend on the particular proximity model employed. In the case of a vector space model employing term frequency inverse document frequency, the comparison may be performed by simply multiplying a query vector with a corpus vector to produce a proximity value. However, other types of proximity calculations are also possible.

At 1014, the produced proximity values are stored. In some implementations, the proximity values may be stored in a query result cache 146. Alternately, or additionally, proximity values may be stored locally within the analytics node for transmission directly to the distributed query system.

At 1016, a determination is made as to whether to select an additional query object for analysis. According to various embodiments, each additional corpus object may be selected until the distributed query portion assigned to the analytics node is fully executed.

In particular embodiments, one or more of the operations shown in FIG. 11 may be performed in an order other than that shown. For example, multiple query object vectors associated with a distributed query job portion may be selected, retrieved, and/or compared with the object query vector in parallel rather than in sequence. For instance, the comparison implemented at operation 1012 may be implemented as a matrix multiplication. As another example, proximity values may be stored in batches rather than upon each individual computation.

FIG. 11 illustrates an example of a job distribution method 1100, performed in accordance with one or more embodiments. According to various embodiments, the method 110 may be performed by a query dispatch engine, such as the query dispatch engine 118 discussed with respect to FIG. 1. The job distribution method 1100 may be performed in order to execute a query in parallel across more than one analytics nodes.

At 1102, a request to execute a distributed query job is received. According to various embodiments, the request to execute a distributed query job may be generated by the distributed query system when the query tracking subsystem 110 includes one or more unexecuted query jobs. For example, queries may be executed on an individual basis. Alternately, queries may be batched together and then executed in batches. The request to execute the distributed query job may therefore identify one or more unexecuted distributed query jobs to execute at the same time.

At 1104, the number of active analytics nodes is adjusted based on the request. According to various embodiments, the number of active analytics nodes may be adjusted to ensure that a sufficient number of active analytics nodes is activated for the query request to be executed in a timely fashion. Specific techniques for adjusting the number of active analytics nodes are discussed in detail with respect to the method 1200 shown in FIG. 12.

At 1106, a set of query objects associated with the distributed query job is determined. In some implementations, a query object vector associated with a particular query may be compared with corpus vectors associated with every object included in the query system. Alternately, the query object vector may be compared against only a subset of the available corpus objects. For example, a query may specify that a query data object is to be compared against only those objects associated with a date that precedes a designated threshold date or meets one or more other characteristics. In order to execute such a request, the distributed query system 102 may transmit a request to the object metadata repository 144 to identify the corpus objects that meet the designated characteristics.

At 1108, a set of analytics nodes is selected for performing the distributed query job. According to various embodiments, the number and identifies of the analytics nodes selected may depend in part on the computing resources available at the analytics nodes. For example, if a load is evenly distributed across all computing nodes in the pool, then all analytics nodes may be selected for performing the distributed query job. However, in some configurations individual nodes may be configured for executing query portions that are specific to particular types of objects. In that case, the analytics nodes selected for performing the distributed query job will depend on the set of query objects determined at operation 1106. Also, in some configurations evenly dividing a query over a very large pool of nodes may impose a significant communications penalty in comparison to the reduction in execution gained by the additional parallelization. In such instances, a subset of the total available analytics nodes may be selected so as to reduce the communications penalty while maintaining the benefits of parallelization.

At 1110, a subset of corpus objects is determined for each of the selected analytics nodes. According to various embodiments, each query object vector may be compared with potentially tens or hundreds of millions of corpus object vectors. These corpus object vectors may be divided among many different analytics nodes to facilitate faster and more efficient computation. For example, if a query object vector is to be compared against 300 million corpus vectors in a node pool having 150 analytics nodes, then each analytics node may be assigned a 2 million vector subset of the corpus vectors to subset.

At 1112, a job request message is transmitted to each of the analytics nodes. In particular embodiments, the job request message may include information such as one or more query object vectors associated with the one or more query jobs associated with the distributed query job execution request. The job request message may also include information indicating to the analytics node the subset of corpus objects assigned to the analytics node for comparing against the query object vectors.

In particular embodiments, one or more of the operation shown in FIG. 11 may be omitted. For example, the number of active analytics nodes may be adjusted intermittently, and not necessarily upon each execution of a job distribution method.

In particular embodiments, one or more of the operations shown in FIG. 11 may be performed in an order other than that shown. For example, the set of query objects associated with the distributed query job may be determined prior to adjusting the active analytics nodes. Then, the number and/or characteristics of the set of query objects may be used to facilitate the adjustment of the active analytics nodes.

In particular embodiments, one or more of the operations shown in FIG. 11 may be executed on an individual analytics node rather than on the distributed query system itself. For example, an individual node may retrieve a portion of a query job directly from the query tracking subsystem 110. Such a retrieval may occur, for instance, when the individual node includes under-utilized computing resources. In this way, the system may more efficiently utilize the computing resources available across different nodes.

FIG. 12 illustrates an example of a node management method 1200, performed in accordance with one or more embodiments. According to various embodiments, the method 1200 may be performed at a node management engine such as the node management engine 120 discussed with respect to FIG. 1. The node management method 1200 may be performed in order to ensure that the pool of active and available analytics nodes is appropriate given the query load carried by the system.

At 1202, a request to adjust analytics nodes is received. According to various embodiments, the request may be generated as part of a job distribution method. For instance, the request may be generated as discussed with respect to operation 1104 shown in FIG. 11. Alternately, or additionally, the request may be generated periodically or dynamically even in the absence of the execution of a job distribution method. For example, the node management engine 120 may periodically adjust analytics nodes to provide for efficient utilization of computing resources.

At 1204, job queue information is retrieved. According to various embodiments, the job queue information may indicate the number and/or other characteristics associated with any of various types of queries to be executed. For example, the node management engine 120 may retrieve from the query tracking subsystem 110 an indication of the number of outstanding queries currently being tracked. In some instances, the node management engine 120 may also request information such as the types of queries being tracked.

At 1206, a target capacity level is determined based on the retrieved job queue information. According to various embodiments, the target capacity level may be strategically determined based on factors such as the time targeted for query execution. If faster query execution is desired, then the target capacity level may be set higher. However, setting a higher target capacity level may incur a corresponding tradeoff in that additional computing resources may be required.

In particular embodiments, the target capacity level may be increased if the number of jobs included in the job queue is high and/or increasing in magnitude, and may be decreased if the number of jobs included in the job queue is low and/or decreasing in magnitude. In some instances, the target capacity level may be determined at least in part based on the types of jobs included in the job queue. For example, some types of queries may require more computing resources than other types of queries based on the number and type of query object included in the query and/or the number and type of corpus objects in the search pool.

At 1208, a current capacity level is determined for active analytics nodes. According to various embodiments, the current capacity level may indicate information such as the number of active analytics nodes and/or the amount or portion of computing resources being utilized on those active analytics nodes. For example, the current capacity may include 300 nodes operating at an average capacity of 96% load over a period of 15 minutes.

In particular embodiments, the mechanisms for determining the current capacity level may depend on the particular characteristics of the systems architecture employed. For example, if an on-demand cloud computing architecture is employed, then information such as the number and/or computing nodes active in the system may be determined by sending a request to a management system associated with the on-demand cloud computing architecture.

At 1210, a determination is made as to whether the target capacity level exceeds the current capacity level. If the target capacity level exceeds the current capacity level, then at 1212 one or more deactivated analytics nodes are activated. At 1214, a determination is made as to whether the current capacity level exceeds the target capacity level. If the current capacity level exceeds the target capacity level, then at 1216 one or more of the activated analytics nodes is deactivated.

In particular embodiments, the number of nodes deactivated at 1212 or activated at 1216 may depend on factors such as the magnitude of the difference between the current capacity level and the target capacity level. For example, the system may divide the difference in magnitude by the approximate, average, or estimated capacity of a node to determine the number of nodes to activate or deactivated.

According to various embodiments, the nature of the operation taken to activate or deactivate a node will depend on characteristics of the computing hardware on which the data analytics nodes are implemented. For instance, in a cloud computing environment, an automatic scaling system may activate or deactivate nodes as necessary.

In particular embodiments, activating a node may involve transmitting an instruction to the cloud computing system to reserve an additional computing device. The additional computing device may include hardware such as a processor, memory, and a communications interface. When the additional computing device is reserved, it may be loaded with standardized software for the performance of techniques and procedures arranged as described herein.

In particular embodiments, activating a node may involve assigning and/or reassigning a designated subset of corpus vectors associated with corpus data objects. For example, each active analytics node may be responsible for executing query portions against a designated subset of corpus vectors. By dividing the computing load in this way, communications overhead involved in retrieving corpus vectors from the vector repository 142 may be retrieved. However, when one or more new nodes are added, then each node may need to update the set of vectors for which it is responsible. For example, the node management engine 120 may transmit a message to each of the nodes indicating an updated set of corpus vectors for comparison. Then, each analytics node may delete corpus vectors for which it is no longer responsible and/or retrieve corpus vectors for which it is newly responsible.

In particular embodiments, deactivating a node may involve transmitting an instruction to either or both of the cloud computing system and/or the node itself to terminate computing processes on the node and to return the use of the node to the cloud computing system. When deactivated the node may clear temporary memory and/or one or more attached storage devices.

In particular embodiments, either or both of the determinations made at operations 1210 and 1214 may be made in a fuzzy or windowed manner. For example, in order to activate one or more deactivated data analytics nodes, the target capacity level may need to exceed the current capacity level by some designated threshold and/or for some designated period of time. As another example, in order to deactivate one or more activated data analytics nodes, the current capacity level may need to exceed the target capacity level by some designated threshold and/or for some designated period of time.

In particular embodiments, one or more of the operation shown in FIG. 12 may be omitted. For example, the target capacity level may be determined based on information other than retrieved job queue information. In some instances, information such as an average query execution time may be used instead to determine a target capacity level. In this case, retrieving job queue information as described with respect to operation 1204 may be unnecessary.

In particular embodiments, one or more of the operations shown in FIG. 12 may be performed in an order other than that shown. For example, the determinations made at operations 1210 and 1214 may be made concurrently or in a reversed order.

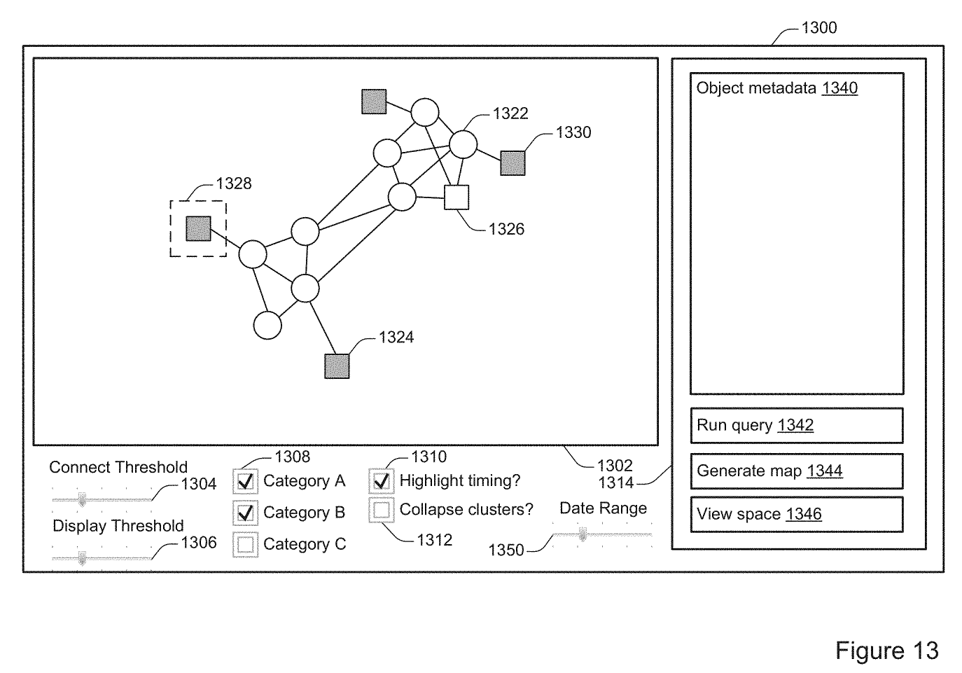

FIG. 13 illustrates an example of a user interface 1300, provided in accordance with one or more embodiments. According to various embodiments, the user interface 1300 may be used to present visual representations of query results to users.

The user interface 1300 includes a visual representation 1302. The visual representation 1302 shown in FIG. 13 is a proximity map. However, other visual representations may be employed, such as the spatial plots shown in FIGS. 8 and 9.

According to various embodiments, the proximity map 1302 represents the neighbors of a focal point by query distance. For example, the system may query millions of objects to find the nearest objects to the focal point. Then, a subset of these objects may be selected for presentation. The subset selected for presentation may include the nearest objects by proximity, such as the nearest 10, 50, 250, or 1,000 objects. Alternately, or additionally, other criteria may be used to select objects, such as restricting the subset to objects that meet one or more designated metadata criteria.

The proximity map 1302 includes nodes 1324, 1326, 1322, 1330, and 1328. Each node corresponds with one or more objects represented in a query result. In the proximity map 1302, two objects may be presented as connected if the distance between those two objects is sufficiently close. According to various embodiments, the specific threshold or thresholds used to determine if too objects are sufficiently close may depend on factors such as user input, the number of objects presented in the visual representation, or a statistical average of the distance between represented objects. For example, a minimum spanning tree may be calculated to ensure that all the graph of displayed objects is fully connected. As another example, two objects may be connected if the distance between those two objects is below a designated level. In particular embodiments, a combination of such criteria may be used.

At 1304, a connect threshold slider is shown. According to various embodiments, the connect threshold slide 1304 may be used to specify the distance threshold required to display two objects as connected. Thus, the user may control the granularity of the clustering represented in the proximity map 1302.

At 1306, a display threshold slider is shown. According to various embodiments, the display threshold slide may be used to specify the proximity to the focal point used to select objects to include in the proximity map 1302.

At 1308, a category checkbox is shown. According to various embodiments, the category checkbox may be used to specify any of various metadata that may be used to select objects to include in the proximity map 1302. For example, objects corresponding to Category A may be represented as circles, while objects corresponding to Category B may be represented as squares. In the example embodiment in which an object may correspond with an academic article, a category may correspond with an author, institution, or journal. In the example embodiment in which an object may correspond with a legal document such as a patent, a category could correspond with an assignee, an inventor, or other such metadata.

At 1350, a temporal selection control is shown. According to various embodiments, the temporal selection control may be used to specify the time period of objects to include in the proximity map 1302. For example, one or more specific dates may be selected where only objects before, between, or after the one or more dates are displayed. In the context of documents, such a date may represent the publication date of the document.

At 1310, a highlight timing checkbox is shown. According to various embodiments, the highlight timing checkbox allows a user to specify whether to separately flag objects based on timing. For example, in FIG. 13, objects that appeared chronologically prior to the focal point are highlighted in grey, while objects that appeared chronologically after the focal point are not highlighted.

In particular embodiments, an identifier may be displayed within each node. For example, the node 1322 may include an identifier such as “46”, which may correspond to a query result index. Then, the same identifier may be used to identify the same object in a different visual representation, such as the spatial plot shown in FIG. 8. In this way, the different visual representations may be used to quickly navigate the query result space.

At 1312, a collapse clusters checkbox is shown. According to various embodiments, the collapse clusters checkbox may be used to reduce visual clutter by presenting clusters of nodes corresponding with proximate objects as a single visual marker. For example, if each member of a set of nodes is entirely connected to all other members of the set, then checking the collapse clusters checkbox may result in those nodes being displayed as a single unit in the proximity map.

At 1340, object metadata is shown. Upon the initial generation of the visual representation 1302, the object metadata 1340 may correspond to the focal point of the visual representation. However, when a user selects an object represented in the visual representation, such as object 1328, then the object metadata 1340 may be updated to reflect the selected visual representation. Examples of the types of metadata that may be displayed are discussed in further detail elsewhere in this application.

At 1342, 1344, and 1346, buttons are shown that allow the user to perform additional actions for a selected object. For example, at 1342, the user can provide user input requesting to run a full report for the selected object. At 1344, the user can request to generate a proximity map with the selected object as the focal point rather than the original focal point for the visual representation. At 1346, the user can generate a spatial plot with the selected object as the focal point, as shown in FIGS. 8 and 9.

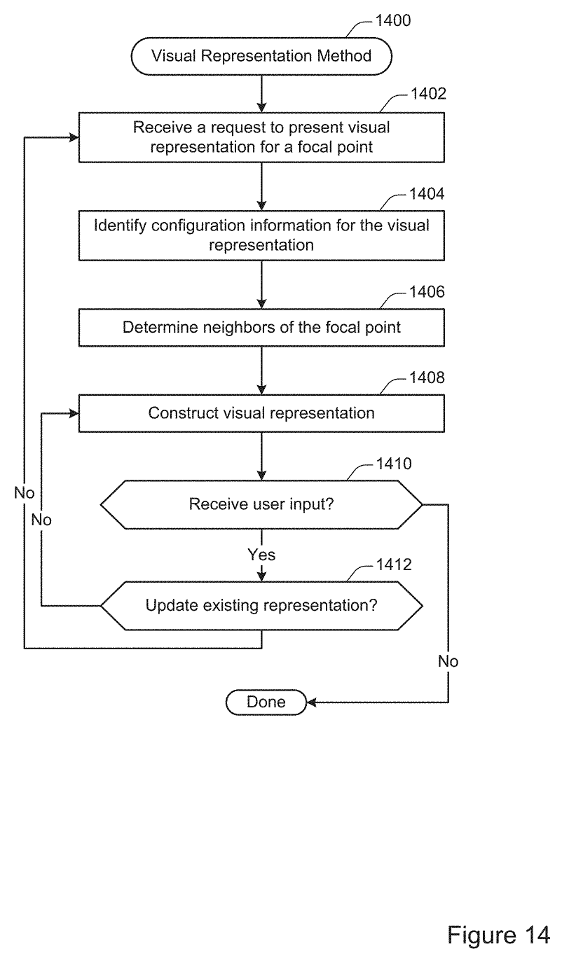

FIG. 14 illustrates an example of a visual representation method 1400, performed in accordance with one or more embodiments. According to various embodiments, the method 1400 may be performed at a query system such as the system shown in FIG. 1. The method 1400 may be used to generate and/or update a user interface such as the user interfaces shown in FIGS. 8, 9, and 13.

At 1402, a request to present a visual representation of a focal point is received. According to various embodiments, the request may be generated manually, based on user input, or upon the detection of a triggering condition. For example, the request may be generated automatically upon the execution of a query centered on the focal point.

At 1404, configuration information is identified for the visual representation. According to various embodiments, the configuration information may include default or initial settings for the representation, such as the settings shown in FIG. 13. For example, the configuration information may include one or more thresholds for which neighbors of the social point are presented in the visual representation. As another example, the configuration may include one or more settings such as particular categories of objects to include in the visual representation.

In some embodiments, configuration information may be determined automatically. For example, the system may store default configuration information to use with various visual representations. As another example, the system may determine suitable configuration information based on the query results. Alternately, user accounts may be associated with specified configuration information, or configuration information may be determined based on user input.

As 1406, neighbors of the focal point are determined. According to various embodiments, the neighbors may identified by relying on the query results to identify objects that are highly proximate to the focal point. For example, all objects whose proximity to the focal point exceeds a designated threshold configuration parameter may be selected. As another example, the closest X objects to the focal point may be identified, where X is a configuration parameter. As yet another example, some combination of proximity threshold and object count threshold may be employed.

At 1408, the visual representation is constructed. Techniques for constructing the visual representation were discussed in additional detail with respect to FIGS. 7, 8, 9, 13, and elsewhere herein. At 1410, a determination is made as to whether user input is received. If user input is received, then at 1412 a determination is made as to whether to update the existing representation. For example, if the user input is associated with a configuration parameter such as a distance threshold or a display category, the existing representation may be updated. If instead the user input is associated with a request to generate a separate visual representation such as a spatial representation or a new map, then a new representation may be generated.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

1. A system comprising:
a query input interface operable to receive from a client machine a query request message identifying a query data object;
a query execution subsystem implemented on a hardware processor and operable to produce a query object vector based on the query data object, the query object vector including a designated plurality of data values that each correspond with a respective dimension in a vector space;
a plurality of data analytics nodes that each include a respective one or more processors and a respective memory module, each of the data analytics nodes operable to:
receive a respective query subset request message that includes the query object vector,
retrieve a respective corpus object vector for each of a respective subset of corpus data objects, each of the respective corpus object vectors including a respective plurality of data values that each corresponds with a respective dimension in a vector space,
for each of the corpus object vectors, compare each value in the query object vector with a respective value in the corpus object vector to produce a proximity value, the proximity value indicating a distance between the query object vector and the corpus object vector in the vector space; and
a query response subsystem operable to:
receive one or more of the proximity values determined by the data analytics nodes,
determine a respective temporal coordinate for each of a subset of the proximity values, each respective temporal coordinate identifying a respective point in time associated with the respective corpus data object associated with the respective proximity value,
transmit a response message to the client machine providing access to a user interface that includes a graphical representation of a coordinate system, each of the subset of the proximity values associated with a respective indicator positioned within the representation of the coordinate system, a first axis of the graphical representation of the coordinate system corresponding with the respective temporal coordinate, a second axis of the graphical representation of the coordinate system corresponding with the respective proximity value.

2. The system recited in claim 1, wherein the subset of proximity values includes all proximity values that exceed a designated threshold.

3. The system recited in claim 1, wherein the query data object is associated with a focal temporal coordinate, the focal temporal coordinate identifying a focal point in time associated with the query data object, and wherein the query data object is associated with a focal indicator positioned within the coordinate system.

4. The system recited in claim 3, wherein the coordinate system includes an origin point at an intersection of the first axis and the second axis, and wherein the focal indicator is positioned at the origin point.

5. The system recited in claim 3, wherein the query response subsystem is further operable to:
identify an originality value associated with the query data object, the originality value comprising a statistical average of a first portion of the proximity values, the first portion of the proximity values consisting of each of the subset of the proximity values having a temporal coordinate less than the focal temporal coordinate; and
transmit the originality value to the client machine via the user interface.

6. The system recited in claim 3, wherein the query response subsystem is further operable to:
identify a legacy value associated with the query data object, the legacy value comprising a statistical average of a first portion of the proximity values, the first portion of the proximity values consisting of each of the subset of the proximity values having a temporal coordinate greater than the focal temporal coordinate; and
transmit the legacy value to the client machine via the user interface.

7. The system recited in claim 3, wherein the query response subsystem is further operable to:
identify a latency value associated with the query data object, the latency value comprising a statistical average of the temporal coordinates for a first portion of the proximity values, the first portion of the proximity values consisting of each of the subset of the proximity values having a temporal coordinate less than the focal temporal coordinate; and
transmit the latency value to the client machine via the user interface.

8. The system recited in claim 3, wherein the query response subsystem is further operable to:
identify a continuity value associated with the query data object, the continuity value comprising a statistical average of the temporal coordinates for a first portion of the proximity values, the first portion of the proximity values consisting of each of the subset of the proximity values having a temporal coordinate greater than the focal temporal coordinate; and
transmit the continuity value to the client machine via the user interface.

9. The system recited in claim 1, wherein the query data object and each of the corpus data objects is a multi-page text document.

10. The system recited in claim 9, wherein each of the dimensions in the vector space corresponds to a respective one or more words that occurs in one or more of the corpus data objects.

11. The system recited in claim 9, wherein each of the dimensions in the vector space corresponds to a respective semantic property associated with one or more of the corpus data objects.

12. A method comprising:
at a query input interface, receiving from a client machine a query request message identifying a query data object;
at a query execution subsystem implemented on a hardware processor, producing a query object vector based on the query data object, the query object vector including a designated plurality of data values that each correspond with a respective dimension in a vector space;
at each of a plurality of data analytics nodes that each include a respective one or more processors and a respective memory module:
receiving a respective query subset request message that includes the query object vector,
retrieving a respective corpus object vector for each of a respective subset of corpus data objects, each of the respective corpus object vectors including a respective plurality of data values that each corresponds with a respective dimension in a vector space,
for each of the corpus object vectors, comparing each value in the query object vector with a respective value in the corpus object vector to produce a proximity value, the proximity value indicating a distance between the query object vector and the corpus object vector in the vector space; and
at a query response subsystem,
receiving one or more of the proximity values determined by the data analytics nodes,
determining a respective temporal coordinate for each of a subset of the proximity values, each respective temporal coordinate identifying a respective point in time associated with the respective corpus data object associated with the respective proximity value,
transmitting a response message to the client machine providing access to a user interface that includes a graphical representation of a coordinate system, each of the subset of the proximity values associated with a respective indicator positioned within the representation of the coordinate system, a first axis of the graphical representation of the coordinate system corresponding with the respective temporal coordinate, a second axis of the graphical representation of the coordinate system corresponding with the respective proximity value.

13. The method recited in claim 1, wherein the subset of proximity values includes all proximity values that exceed a designated threshold.

14. The method recited in claim 1, wherein the query data object is associated with a focal temporal coordinate, the focal temporal coordinate identifying a focal point in time associated with the query data object, and wherein the query data object is associated with a focal indicator positioned within the coordinate system.

15. The method recited in claim 14, wherein the coordinate system includes an origin point at an intersection of the first axis and the second axis, and wherein the focal indicator is positioned at the origin point.

16. The method recited in claim 14, wherein the query response subsystem is further operable to:
identify an originality value associated with the query data object, the originality value comprising a statistical average of a first portion of the proximity values, the first portion of the proximity values consisting of each of the subset of the proximity values having a temporal coordinate less than the focal temporal coordinate; and
transmit the originality value to the client machine via the user interface.

17. The method recited in claim 3, wherein the query response subsystem is further operable to:
identify a legacy value associated with the query data object, the legacy value comprising a statistical average of a first portion of the proximity values, the first portion of the proximity values consisting of each of the subset of the proximity values having a temporal coordinate greater than the focal temporal coordinate; and
transmit the legacy value to the client machine via the user interface.

18. One or more non-transitory machine-readable media having instructions stored thereon for performing a method, the method comprising:
at a query input interface, receiving from a client machine a query request message identifying a query data object;
at a query execution subsystem implemented on a hardware processor, producing a query object vector based on the query data object, the query object vector including a designated plurality of data values that each correspond with a respective dimension in a vector space;
at each of a plurality of data analytics nodes that each include a respective one or more processors and a respective memory module:
receiving a respective query subset request message that includes the query object vector,
retrieving a respective corpus object vector for each of a respective subset of corpus data objects, each of the respective corpus object vectors including a respective plurality of data values that each corresponds with a respective dimension in a vector space,
for each of the corpus object vectors, comparing each value in the query object vector with a respective value in the corpus object vector to produce a proximity value, the proximity value indicating a distance between the query object vector and the corpus object vector in the vector space; and
at a query response subsystem,
receiving one or more of the proximity values determined by the data analytics nodes,
determining a respective temporal coordinate for each of a subset of the proximity values, each respective temporal coordinate identifying a respective point in time associated with the respective corpus data object associated with the respective proximity value,
transmitting a response message to the client machine providing access to a user interface that includes a graphical representation of a coordinate system, each of the subset of the proximity values associated with a respective indicator positioned within the representation of the coordinate system, a first axis of the graphical representation of the coordinate system corresponding with the respective temporal coordinate, a second axis of the graphical representation of the coordinate system corresponding with the respective proximity value.

19. The one or more non-transitory computer readable media recited in claim 18, wherein the subset of proximity values includes all proximity values that exceed a designated threshold.

20. The one or more non-transitory computer readable media recited in claim 18, wherein the query data object is associated with a focal temporal coordinate, the focal temporal coordinate identifying a focal point in time associated with the query data object, and wherein the query data object is associated with a focal indicator positioned within the coordinate system.
